(19) United States
(12) Patent Application Publication
(10) Pub. No.: US 2012/0073431 A1
(43) Pub. Date: Mar. 29, 2012

(54) Digital Hydraulic Controller

(75) Inventors: Arto Ikonen, Jarvenpaa (FI); Eero Suomi, Hameenlinna (FI); Ville Hopponen, Mantsala (FI)

(73) Assignee: METSO PAPER, INC., Helsinki (FI)

(21) Appl. No.: 13/322,800

(22) PCT Filed: Apr. 13, 2010
(86) PCT No.: PCT/EP2010/054795

§ 371 Date: Nov. 28, 2011

(30) Foreign Application Priority Data
May 29, 2009 (DE) 10 2009 026 606.2

(51) Int. Cl. F15B 13/04; F15D 1/00

(52) U.S. Cl. 91/446; 137/613; 91/471

(57) ABSTRACT

A digital hydraulic controller has at least two rows of valve elements: one can connect a supply line to a controller output, the other can connect the controller output to an outlet line. The valve elements of each row are connected in parallel and are switchable individually or simultaneously in different combinations with each other and have different flow cross sections. The valve element with the smallest flow cross section is present twice in the row. A system unit has a differential cylinder and a digital hydraulic controller with four rows of valve elements, two of which are, with their common controller output, connected to the one pressure chamber of the differential cylinder, while the other two rows of valve elements are, with their common controller output, connected to the other pressure chamber of the differential cylinder. The differential cylinder can be used as a precisely adjustable linear actuator.

### CROSS REFERENCES TO RELATED APPLICATIONS

This application is a U.S. national stage application of International App. No. PCT/EP2010/054795, filed Apr. 13, 2010, the disclosure of which is incorporated by reference herein and claims priority on German Application No. 10 2009 026 606.2 filed May 29, 2009.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a controller which can in particular be used in a hydraulic system for a machine for producing a fibrous material web, e.g. a paper or board machine.

In paper machines, hydraulics is widely used as a means of operation and control; in particular, actuators by means of which great forces can be adjusted and exerted with high precision are hydraulically driven.

Normally a working fluid, e.g. hydraulic oil, which is pressurized by a pump, is used. The introduction of the pressurized hydraulic oil into a hydraulic actuator, such as a hydraulic cylinder or a hydraulic motor, is typically controlled by a proportional control valve or a proportional valve which can be driven electrically, hydraulically or pneumatically.

Such a control valve has a movable or displaceable spool valve or control piston which, in response to its position in an associated valve housing, can adjust a target pressure at the output by regulating down the pressure of the hydraulic oil supplied by the pump. The mobility of the control piston in the valve housing mandatorily requires a certain play or clearance between control piston and valve housing so that inner leakage of the control valve is unavoidable. The clearance must not be selected to be too narrow, since otherwise the valve would be too prone to contamination in the hydraulic oil.

Recently, alternative pressure controllers have been developed which shall consistently be referred to as digital hydraulic pressure controllers in the present application. If such digital hydraulic pressure controllers are used as pressure reducing regulators, they will consistently be referred to as digital hydraulic pressure reducers in the present application.

The mode of operation of the digital hydraulic pressure controllers or pressure reducers is, for example, described in the journal Fluid No. 7-8, 2008, on pages 12, 13. For the sake of improved readability of the present application, the mode of operation of digital hydraulic pressure controllers will be briefly summarized again:

In the simple case, a digital hydraulic pressure controller consists of a row of valves which are switched in parallel and which merely have an ON/OFF function; i.e. they are simple ON/OFF switching valves which permit or interrupt a flow and can consistently be referred to as valves in the present application. All of the valves are, on the one hand, connected to a common supply line and, on the other hand, to a common output line. The valves themselves can be conventional solenoid valves, i.e. valves having an electromagnetic drive. As a matter of course, other drive forms may also be selected.

By connecting or installing throttle elements or by the valves themselves, it is ensured that the valves have different flows when they are opened. If, for example, four valves are provided, the flow rates Q in the individual passages, each of which is selectively openable by the associated valve, can be at a ratio of 1:2:4:8 with respect to each other; in the case of a larger number of valves, this row is continued accordingly.

By opening and closing individual valves or valve combinations which are determined and selected by a computer on the basis of mathematical models, a very rapid and precise pressure adjustment in the output line or in the actuator connected thereto can be achieved. This is accomplished by replacing the analog control curve of the proportional control valve described above by a digitally generated (approximated) control curve. Due to the omission of non-linearities and/or hysteresis of the analog proportional valve, this curve may be a straight line which is approximated stepwise and allows a set point to be approached quickly and (almost) free from overshoot.

In the pressure controllers of the kind referred to, a plurality of valves (in the following designated as valve elements which have a switching valve function and a rigid throttle function) can be operated independently of each other. The control curve is represented by switching suitable combinations of the valve elements at the same time. If an individual valve element does not function any longer, the control accuracy certainly decreases, but the control function is maintained.

### SUMMARY OF THE INVENTION

It is the object of the invention to provide a digital hydraulic controller which, by simple means, ensures high control precision even in case of failure of a valve element.

It has been found that valve elements having low flows, i.e. small flow cross sections, are of decisive importance for the precision of the control, and that these valve elements are also those valve elements which are operated most frequently.

This has been looked into as a particular example in the control of the line load in a nip of a calender operated by hydraulic cylinders, and the statement that the valve elements having the low flows, i.e. the small flow cross sections, are of decisive importance for the precision of the control has been confirmed.

According to the invention, a digital hydraulic controller comprises at least two rows of valve elements of which the one row of valve elements can connect a supply line to a controller output and the other row of valve elements can connect the controller output to an outlet line. The valve elements of each row of valve elements are connected in parallel and are switchable individually or simultaneously in different combinations with each other. At least some of the valve elements of a row of valve elements have a respectively different flow cross section. According to the invention, at least that valve element of each row of valve elements which has the smallest flow cross section is present twice in the row of valve elements.

In this way, it is ensured that in case of failure of the valve element having the smallest flow cross section, a constant control quality is maintained due to redundancy of this function.

This configuration moreover involves the advantage that according to experience, also valve elements with a nominally identical construction have in fact slightly different flow cross sections or allow different flows to pass. In a digital hydraulic controller, these differences can be used to the effect that, when determining a combination of valve elements to be switched for a controller intervention, the more suitable one of the two valve elements of the smallest flow is selected. Thus, control can be improved even further.

Preferably, the valve elements are composed of an electromagnetic switching valve and a throttle provided on the valve. The throttles can be produced by simple bores and can then be combined with always the same valves. In this way, the elements which have moving parts and are consequently more interference-prone are always the same. This makes the construction less costly and facilitates the storing of spare parts.

Preferably, within a row of valve elements, the valve elements having different flow cross sections are composed such that they have a flow cross section increasing stepwise from valve element to valve element. Preferably, the flow cross section is doubled from step to step.

In an advantageous embodiment, the flow cross sections form a binary row in which the smallest flow cross section amounts to 1 and the other flow cross sections amount to 2, 4, 8 and 16, etc.

Preferably, the digital hydraulic controller according to the invention is designed such that switching valves and throttles are intended and suited for use with fluids, in particular hydraulic oil; alternatively, switching valves and throttles may be intended and suited for use with gases, in particular compressed air. The switching valves may be electromagnetically driven valves.

According to the invention, the controller can be connected to a control apparatus which actuates the switching valves or the switching valve combinations for opening, wherein the control apparatus can control the controller as pressure controller or as flow controller.

The invention can be applied to a system unit comprising a differential cylinder and a digital hydraulic controller, wherein the controller has four rows of valve elements, two of which are, with their common controller output, connected to a pressure chamber of the differential cylinder on the side of the cylinder, while the other two rows of valve elements are, with their common controller output, connected to a pressure chamber of the differential cylinder on the side of the piston rod. In this system unit, a flow sensor can be arranged in a line leading from the controller output to the pressure chamber on the cylinder side. In this embodiment, the flow sensor can be used as position sensor, as will be described later.

Particular advantages are then shown by an arrangement comprising two of such system units in which each differential cylinder acts on a bearing point of a roller supported at both ends thereof, the control apparatus evaluating the signals of the flow sensors as position information of the respective roller end and synchronizing the movement of the two differential cylinders on the basis of this position information.

Different applications of the controller according to the invention will be described in the following.

Normally, for controlling the force generated by a differential cylinder, i.e. a double-acting hydraulic cylinder comprising two chambers each defined by one side of the piston, merely the pressure in one chamber of the cylinder is adjusted, whereas ambient pressure or the pressure in the reservoir (tank pressure) prevails in the other chamber.

If the cylinder shall “push” (e.g. the piston rod shall be extended), the pressure in the chamber on the side of the piston is increased. If, otherwise, the cylinder shall “pull” (e.g. the piston rod shall be retracted), the pressure in the chamber on the side of the rod is increased.

In case of a load change from pushing to pulling or vice versa, control mandatorily passes through a state (dead area) in which no force is exerted by the cylinder, wherein, in this state, there is tank pressure in both chambers. In this state, both chambers are connected to the tank and the piston is virtually loose or free. If, moreover, a large range of forces is to be covered, it is difficult to provide correspondingly sensitive control systems which ensure an accurate control of small forces.

By the precision of a digital hydraulic pressure control, it is possible to simultaneously apply pressure to both chambers of the differential cylinder and to control the pressure in the chambers independently of each other. In this way, it is possible to also adjust very small forces which the hydraulic cylinder shall exert by making both pressure chambers have correspondingly adjusted pressure differences on a high pressure level, i.e. the force adjustment takes place or is assisted by counter-pressure in the pressure chamber working against the desired force.

In addition, there is the advantage that the precision of the digital hydraulic control is better if the input pressure into the controller and the output pressure from the controller have a similar level, i.e. if the pressure drop across the controller is small. This means that the pressure in both chambers can be maintained near the supply pressure (input pressure of the controller), so that the volume flowing through a valve element within the minimum opening time thereof becomes small, and thus especially the sensitive control in the range of small changes is improved. So as to enhance this positive effect, the control apparatus can be designed such that it selects the pressures so that the higher of the two chamber pressures is only slightly below the supply pressure. In this way, independently of the forces to be generated, control is always carried out so as to achieve the best possible control precision.

Furthermore, due to the simultaneous pressure control in both pressure chambers, the change between pushing and pulling in the differential cylinder can be controlled much better; it is sufficient if, merely by changing the pressure in one pressure chamber, the counter force is suitably increased or reduced such that the force of the other pressure chamber is exceeded or underrun. In this way, there does no longer result an uncontrolled state in which both pressure chambers are connected to the tank.

A typical application of the digital hydraulic control technology is the control of pressures applied by rollers and the control of pressure curves in a nip in the cross machine direction CD (CD=cross machine direction).

This digital hydraulic technology can also be used to adjust the orifice of a head box nozzle (slot nozzle) in a paper or board machine. The adjustment of the orifice which, in the CD direction, shall ensure a uniform material discharge from the nozzle slot of a head box usually takes place by means of electric spindle drives. These actuators provided with step motors and a suitable transmission are mounted in a tightly packed manner (approximately every 75 to 150 mm) along the orifice, and the adjustment of the slot width of the slot nozzle takes place by locally (slightly) bending the lower edge of the orifice in the direction of the lower edge of the slot nozzle.

Due to the precision of the control which is achieved by means of the digital hydraulic technology of the kind described above and since, by this hydraulics, a pressure that has been adjusted once is locked in a volume and is then maintained without any further effort, it is possible to accomplish the adjustment of the orifice by means of differential cylinders instead of using the hitherto conventional spindle drives. In this way can be realized a low-maintenance orifice adjusting device which is simple in construction.

Each spindle drive in a usual head box is in this solution replaced by a differential cylinder whose piston rod is connected to a range or position sensor so as to obtain an exact adjustment value for the piston position. As position sensors, different sensor types may be used; for the ambient conditions prevailing at a head box, a so-called LVDT sensor (LVDT=Linear Variable Differential Transformator) is particularly suitable due to its robustness. Other sensor types may be used. For a control, also a force may furthermore be used as feedback parameter.

Depending on the demands on the regulating speed and regulating precision, a simple digital hydraulic controller having two times two to three valve elements (switching valves with throttle) can be provided, the controller adjusting the pressures in the two pressure chambers using feedback control of the actual position such that the orifice adjusts the desired slot width. It is possible to provide each differential cylinder with its own valve elements.

If the required regulating times permit, also solutions may be selected in which, for example, in a kind of multiplex operation, only one controller is present which can adjust the pressures for two pressure chambers in two central pressure lines. In this multiplex operation, the individual differential cylinders are individually connected one after the other to the central pressure lines and the target pressures in the two chambers of this differential cylinder are then adjusted by the central pressure controller. Here, the individual position sensor can supply a parameter for the adjustment. Then, the two chambers are sealed and thereby also isolated from the central lines. In this way, two simple switching valves are sufficient for each differential cylinder and very few lines are required.

Also conceivable are mixed forms, in which groups of differential cylinders in multiplex operation can be adjusted individually or jointly in superposition with a mechanical (pre)adjustment. Of course, a controller of its own may also be assigned to each differential cylinder.

Due to the low frequency of the adjustment and due to the short regulating distances, a very small pump suffices for the pressure supply, the pump being, for reasons of expediency, coupled to a pressure reservoir so that an approximately constant input pressure at the controller or controllers is sufficient.

### BRIEF DESCRIPTION OF THE DRAWINGS

FIG. 1 schematically shows a configuration of such a differential cylinder for the orifice adjustment with only one cylinder.

FIG. 2 shows an arrangement for detecting the piston position of differential cylinders 1 in a hydraulic system comprising digital pressure controllers 2.

### DESCRIPTION OF THE PREFERRED EMBODIMENTS

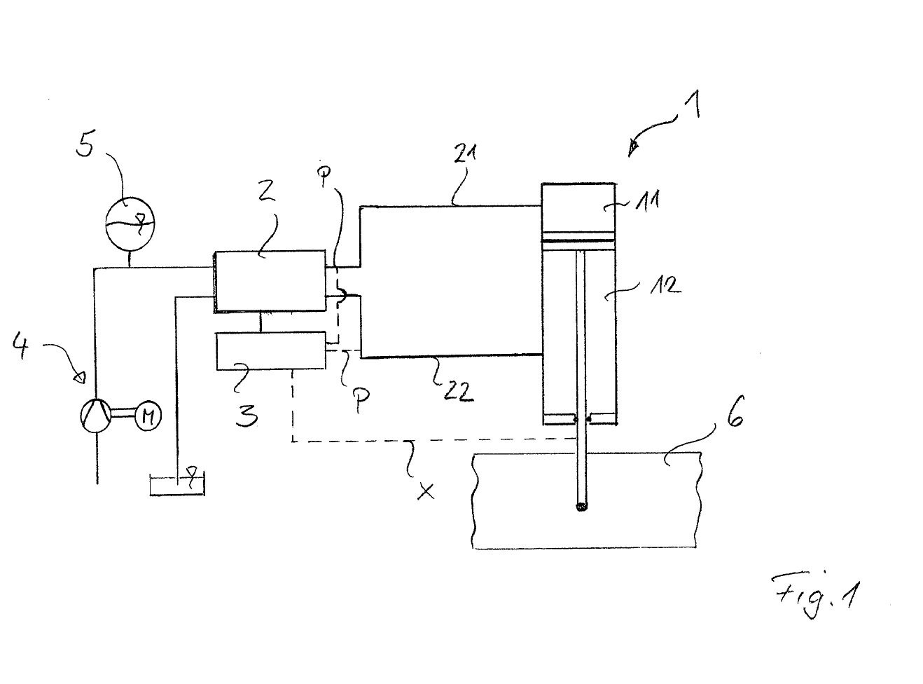

The differential cylinder 1 has two pressure chambers 11 and 12. The piston rod of the cylinder 1 is fixedly coupled to an orifice 6 and the cylinder 1 is operative to adjust the orifice 6 in FIG. 1 upwards and downwards.

Lines 21 and 22 are connected to the associated pressure chambers 11 and 12 and to a pressure controller 2 which is a digital hydraulic controller described in detail above. A control apparatus 3 receives as information a position signal x, which is output by a position sensor (not shown), and the two pressures in chambers 11 and 12. Further influence parameters on the desired chamber pressures or the target position of the piston rod (or the orifice) may result from calculations, other requirements, or measured variables, etc. In accordance with these requirements given by the control apparatus 3, the pressure controller 2 then adjusts the desired pressures in the chambers 11 and 12.

Furthermore, FIG. 1 also shows a supply unit 4 having a pump and a tank for the working fluid, and reference sign 5 designates a pressure reservoir.

Apart from conventional hydraulic fluids, also water and/or aqueous emulsions may be used as working fluid, which is easy to handle and does not represent an environmental risk. As only small movements are made and only ON/OFF switching valves are used in the pressure controller, lubricity of hydraulic oil is not absolutely necessary.

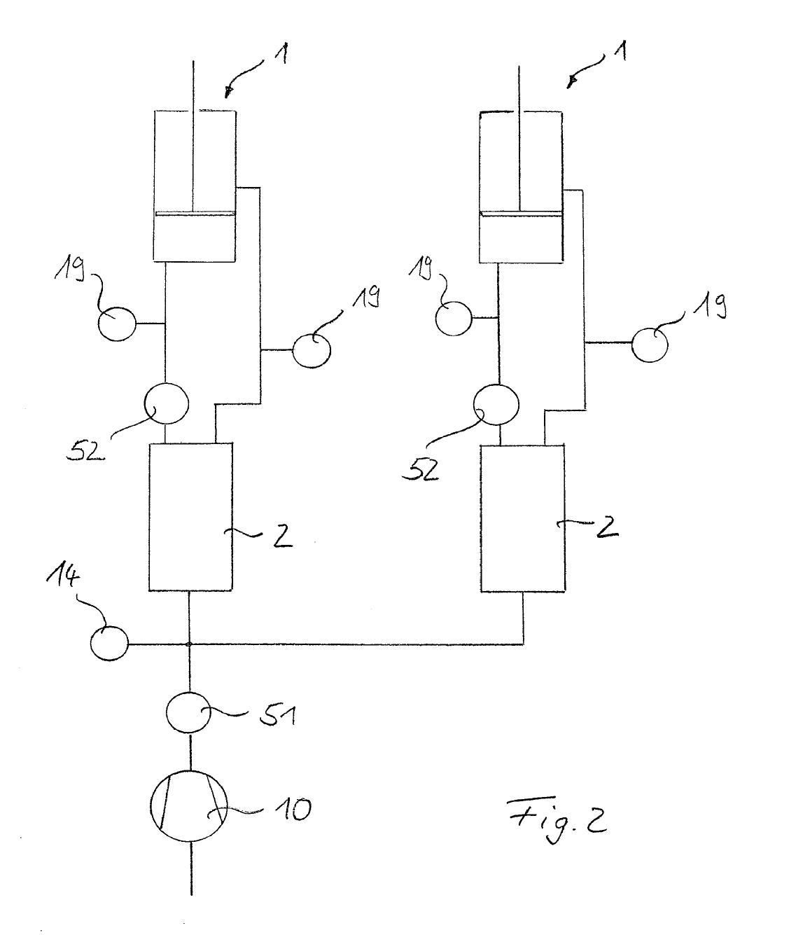

FIG. 2 shows an arrangement for detecting the piston position of differential cylinders 1 in a hydraulic system comprising digital pressure controllers 2.

A pump 10 delivers working fluid to two pressure controllers 2 via a flow meter 51 which measures the volume flow supplied to the system by the pump 10 on the basis of the working fluid, the two pressure controllers being connected to a differential cylinder 1 each. The delivery pressure of the pump 10 and, as the case may be, the temperature are detected at the measuring point 14. Flow meters 52 detect the inflow of working fluid into the pressure chamber on the cylinder side of the respective cylinder 1. The measuring points 19 provide measured values of the pressures and, as the case may be, temperatures in the pressure lines to the cylinders 1. Due to the loss-free mode of operation of the digital hydraulic pressure controllers 2, the amount of working fluid detected by the flow meters 52 corresponds to the filling quantity which is actually present in the respective pressure chambers on the cylinder side and which is a reliable criterion for the piston position.

The moving of heavy loads, such as rollers in a paper machine, by means of two hydraulic cylinders 1 is always also a synchronization problem of the movement of the two piston rods. As a result of the flow measurements a position sensor for the piston position is formed, wherein the flow meters 52 should measure accurately. Preferably, gear wheel systems, which are relatively accurate, are used for this purpose. Moreover, the flow measurement by means of the flow meter 51 in the supply line provides an additional measured value which can be used for checking the results of the flow meters 52 for the pressure chambers as to their plausibility.

Due to the indirect measurement, the absolute value for the piston position may also be slightly erroneous; however, the two measured values (each for one cylinder 1) which are detected simultaneously and are exposed to the same external influences may provide information as to how synchronously the two pistons move, or whether the movements deviate from each other in an inadmissibly strong manner. These findings may be used to possibly improve synchronization by means of suitable measures. Furthermore, failures in the hydraulic system can also be inferred from the measured values.

1-14. (canceled)

15. A digital hydraulic controller comprising:
at least two rows of valve elements, one of the rows of valve elements being arranged to connect a supply line to a controller output and the other row of valve elements being arranged to connect the controller output to an outlet line;
wherein each valve element of each row of valve elements has a flow cross section;
wherein the valve elements of each row of valve elements are connected in parallel and are switchable individually or simultaneously in different combinations with each other;
at least some of the valve elements of a row of valve elements have respectively a different flow cross section;
wherein in each row of valve elements there is a smallest valve element which is smaller in flow cross section than the other valve elements in said row; and
wherein the smallest valve element is duplicated so there are two smallest valves in each row of valve elements.

16. The digital hydraulic controller of claim 15 wherein the valve elements are composed of an electromagnetic switching valve and a throttle which defines the flow cross section provided on the valve.

17. The digital hydraulic controller of claim 15 wherein within at least one row of valve elements, said at least some of the valve elements have flow cross sections which increase stepwise from step to step from valve element to valve element.

18. The digital hydraulic controller of claim 17 wherein the flow cross section is doubled from step to step.

19. The digital hydraulic controller of claim 15 wherein the smallest valve flow cross section is 1 in relation to the flow cross sections of 2, 4, 8 and 16 of other valve elements respectively in the row.

20. The digital hydraulic controller of claim 16 wherein the valve elements are of a type used with liquid.

21. The digital hydraulic controller of claim 16 wherein the valve elements are of a type used with hydraulic oil.

22. The digital hydraulic controller of claim 16 wherein the valve elements are of a type used with gases.

23. The digital hydraulic controller of claim 15 wherein the controller is connected to a control apparatus which actuates the switching valves or combinations of switching valves to open them.

24. The digital hydraulic controller of claim 23 wherein the control apparatus is arranged to control the controller as a pressure controller.

25. The digital hydraulic controller of claim 23 wherein the control apparatus is arranged to control the controller as a flow controller.

26. A system unit comprising:
a differential cylinder having a piston to which a piston rod is attached on a rod side of the piston, the piston defining a piston side and the differential cylinder having a pressure chamber on the piston side, the rod defining the rod side and the differential cylinder having a pressure chamber on the rod side;
a digital hydraulic controller comprising:
two rows of valve elements, one of the rows of valve elements being arranged to connect a supply line to a first controller output and the other row of valve elements being arranged to connect the first controller output to an outlet line, wherein the first controller output is connected to the pressure chamber on the piston side;
two further rows of valve elements, one of the further rows of valve elements being arranged to connect the supply line to a second controller output and the other further row of valve elements being arranged to connect the second controller output to the outlet line, wherein the second controller output is connected to the pressure chamber on the piston rod side;
wherein each valve element of each row of valve elements has a flow cross section;
wherein the valve elements of each row of valve elements are connected in parallel and are switchable individually or simultaneously in different combinations with each other, and wherein at least some of the valve elements of a row of valve elements have respectively a different flow cross section;
wherein each row of valve elements has a smallest valve element which is smaller in flow cross section than the other valve elements in said row; and
wherein the smallest valve element is duplicated so there are two smallest valves in each row of valve elements.

27. The system unit of claim 26 wherein within at least one row of valve elements, said some of the valve elements have flow cross sections which increase stepwise step to step from valve element to valve element.

28. The system unit of claim 27 wherein the flow cross section is doubled from step to step.

29. The system unit of claim 27 wherein the smallest valve flow cross section is 1 in relation to the flow cross sections of 2, 4, 8 and 16 of other valve elements respectively in the row.

30. A method of synchronizing the movement of two differential cylinders supporting a roll at each of its ends, comprising the steps of:
supporting each end of the roll at a bearing point with a system unit as claimed in claim 28;
evaluating a signal from each of the flow sensors as position information of the respective roll ends; and,
synchronizing the movement of each of the differential cylinders on the basis of the position information.

31. An assembly comprising: two system units according to claim 26 wherein each differential cylinder of the two system units acts on a bearing point on one of the ends of a roller, and wherein a control apparatus is installed in signal receiving relation to each of the flow sensors of the two system units, the control apparatus arranged to evaluate the signals of the flow sensors as position information so that the control apparatus can synchronize the movement of the two differential cylinders and the respective roller ends on the basis of the flow sensors signals evaluated to give position information.
